(19) United States
(12) Patent Application Publication
(10) Pub. No.: US 2020/0317466 A1
(43) Pub. Date: Oct. 8, 2020

(54) ELEVATOR SYSTEM

(71) Applicant: Mitsubishi Electric Corporation, Tokyo (JP)

(72) Inventor: Hidenori Koyasu, Tokyo (JP)

(73) Assignee: Mitsubishi Electric Corporation, Tokyo (JP)

(21) Appl. No.: 16/303,151

(22) PCT Filed: Sep. 15, 2016
(86) PCT No.: PCT/JP2016/077269

§ 371 Date: Nov. 20, 2018

(51) Int. Cl. B66B 1/18; B66B 3/02

(52) U.S. Cl. CPC B66B 1/18; B66B 1/468; B66B 3/02

(57) ABSTRACT

Provided is an elevator system capable of protecting the privacy of users. The elevator system includes: a plurality of in-car communication devices provided in a plurality of respective cars; and a group management device configured to, when an in-car communication device in a car that has arrived at a hall receives identification information from a portable terminal by wireless communication and when the car is not a car to which a call has been allocated on the basis of input from the portable terminal corresponding to the identification information, cause the in-car communication device in the car to transmit information indicating that a user has gotten on a wrong car to the portable terminal by wireless communication.

### TECHNICAL FIELD

The present invention relates to an elevator system.

### BACKGROUND ART

For example, PTL 1 discloses an elevator system. In the elevator system, when a user has gotten on a wrong car, a notification device notifies the user of information indicating that the user has gotten on the wrong car by voice.

### CITATION LIST

### Patent Literature

### [PTL 1] Japanese Patent Application Laid-open No. 2012-171741

### [PTL 2] Japanese Patent Application Laid-open No. 2013-060274

### [PTL 3] Japanese Patent Application Laid-open No. 2012-111568

### [PTL 4] WO 2012/147159

### SUMMARY OF INVENTION

### Technical Problem

In the elevator system described in PTL 1, however, the information indicating that the user has gotten on the wrong car is notified to other users as well. Thus, the privacy of the user who has gotten on the wrong car cannot be protected.

The present invention has been made in order to solve the above-mentioned problem. An object of the present invention is to provide an elevator system capable of protecting the privacy of users.

### Solution to Problem

An elevator system according to the present invention includes: a plurality of in-car communication devices provided in a plurality of respective cars; and a group management device configured to, when an in-car communication device in a car that has arrived at a hall receives identification information from a portable terminal by wireless communication and when the car is not a car to which a call has been allocated on the basis of input from the portable terminal corresponding to the identification information, cause the in-car communication device in the car to transmit information indicating that a user has gotten on a wrong car to the portable terminal by wireless communication.

### Advantageous Effects of Invention

According to the present invention, the group management device causes the in-car communication device to transmit information indicating that a user is getting on a wrong car to the portable terminal by wireless communication. Thus, the information is notified to a target user. As a result, the privacy of the user can be protected.

### BRIEF DESCRIPTION OF DRAWINGS

FIG. 1 is a configuration diagram of an elevator system in Embodiment 1 of the present invention.

FIG. 2 is a block diagram of the elevator system in Embodiment 1 of the present invention.

FIG. 3 is a flowchart for describing the outline of operation of a group management device in the elevator system in Embodiment 1 of the present invention.

FIG. 4 is a hardware configuration diagram of the group management device 5 in the elevator system in Embodiment 1 of the present invention.

### DESCRIPTION OF EMBODIMENTS

Embodiments of the present invention are described with reference to the accompanying drawings. In the drawings, the same or corresponding parts are denoted by the same reference symbols. Overlapping descriptions of the parts are simplified or omitted as appropriate.

### Embodiment 1

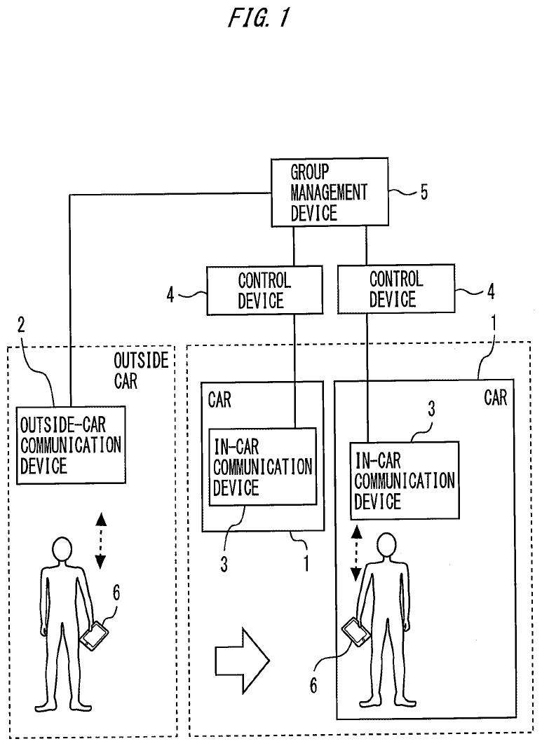

FIG. 1 is a configuration diagram of an elevator system in Embodiment 1 of the present invention.

In the elevator system in FIG. 1, a hoistway (not shown) penetrates each floor of a building (not shown). Each of a plurality of halls (not shown) is provided at each floor of the building. Each of the plurality of halls is opposed to the hoistway. A plurality of cars are provided in the hoistway.

At least one outside-car communication device 2 is provided in a place other than the plurality of cars 1. For example, the plurality of outside-car communication devices 2 are provided at the plurality of respective halls. A plurality of in-car communication devices 3 are provided in the plurality of respective cars 1.

A plurality of control devices 4 are provided correspondingly to the plurality of respective cars 1. For example, each of the plurality of control devices 4 is provided in the hoistway. A group management device 5 is connected to each of the plurality of cars 1.

A portable terminal 6 is carried by a user. For example, the portable terminal 6 is a smartphone. For example, the portable terminal 6 is a tablet.

For example, the user uses the portable terminal 6 to input a destination floor at the hall. The portable terminal 6 transmits hall call information including information indicating the hall, information indicating the input destination floor, and identification information indicating the portable terminal 6 to the outside-car communication device 2 at the hall by wireless communication.

For example, the user uses the portable terminal 6 to input a theme at the hall. Specifically, the user selects from among themes presented on the portable terminal 6 by default at the hall in accordance with his/her own preference about interior. The themes are appropriately set for each of the plurality of cars 1. For example, the themes are set correspondingly to a plurality of kinds of interior that act on the senses of the user other than the sense of taste. For example, illumination, wallpaper, and the color of the floor are set so as to act on the sense of vision of the user. For example, a bright pattern, a dark pattern, a floral pattern, and a forest pattern are set so as to act on the sense of vision of the user. For example, the material of wallpaper such as fluffy material and smooth material is set so as to act on the sense of touch of the user. For example, the material of the floor such as fluffy material and smooth material is set so as to act on the sense of touch of the user. For example, odor such as citrus odor and floral odor is set so as to act on the sense of smell of the user. For example, background music (BGM) such as bustling BGM and relaxing BGM is set so as to act on the sense of hearing of the user. The portable terminal 6 transmits hall call information including information indicating the hall, information indicating the input theme, and identification information indicating the portable terminal 6 to the outside-car communication device 2 at the hall by wireless communication.

The outside-car communication device 2 at the hall transmits the hall call information to the group management device 5 by serial communication. The group management device 5 determines a car 1 to which a call corresponding to the destination floor is allocated as an allocated car on the basis of the hall call information. The group management device 5 registers the call corresponding to the destination floor to a control device 4 corresponding to the allocated car. The control device 4 corresponding to the car 1 controls the traveling of the car 1 on the basis of the call.

The user gets on the car 1 that has arrived at the hall. The in-car communication device 3 in the car 1 receives the identification information from the portable terminal 6 by wireless communication. The in-car communication device 3 in the car 1 transmits the identification information to the corresponding control device 4 by serial communication. The corresponding control device 4 transmits the identification information to the group management device 5 by serial communication.

When the car 1 is not an allocated car based on the input from the portable terminal 6 corresponding to the identification information, the group management device 5 transmits notification information including at least one of information indicating that the user has gotten on a wrong car 1 and information on the allocated car to the corresponding control device 4 by serial communication. The corresponding control device 4 transmits the notification information to the in-car communication device 3 in the car 1 by serial communication. The in-car communication device 3 in the car 1 transmits the notification information to the portable terminal 6 by wireless communication.

For example, the portable terminal 6 notifies the user of information indicating that the user has gotten on a wrong car 1 on the basis of the notification information. For example, the portable terminal 6 notifies the user of information indicating the allocated car on the basis of the notification information.

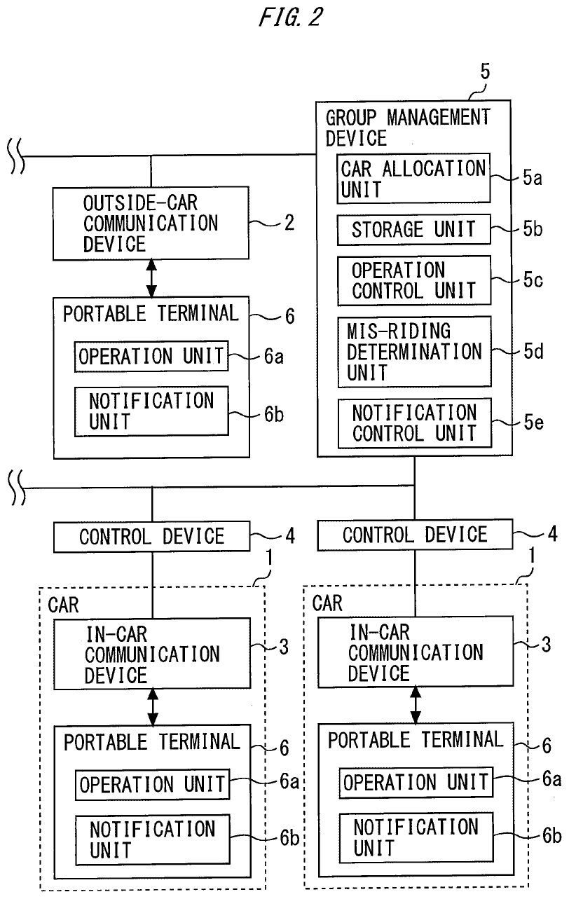

Next, the group management device 5 and the portable terminal 6 are described with reference to FIG. 2.

FIG. 2 is a block diagram of the elevator system in Embodiment 1 of the present invention.

The group management device 5 includes a car allocation unit 5a, a storage unit 5b, an operation control unit 5c, a mis-riding determination unit 5d, and a notification control unit 5e.

The car allocation unit 5a determines an allocated car on the basis of hall call information. The storage unit 5b stores identification information included in the hall call information and information on the allocated car in association with each other. The operation control unit 5c registers a call to a control device 4 corresponding to the allocated car determined by the car allocation unit 5a. The mis-riding determination unit 5d determines whether the user has gotten on a wrong car 1 on the basis of a result of comparison between identification information from the in-car communication device 3 and identification information stored in the storage unit 5b. When it is determined by the mis-riding determination unit 5d that the user has gotten on a wrong car 1, the notification control unit 5e transmits notification information to the control device 4 corresponding to the car 1.

The portable terminal 6 includes an operation unit 6a and a notification unit 6b.

The operation unit 6a receives an input of information through external operation. The notification unit 6b notifies the user of at least one of information indicating that the user has gotten on a wrong car 1 and information indicating the allocated car on the basis of the notification information from the in-car communication device 3. For example, when earphones are connected to the portable terminal 6, the notification unit 6b notifies the user of at least one of information indicating that the user has gotten on a wrong car 1 and information indicating the allocated car by voice. For example, when earphones are not connected to the portable terminal 6, the notification unit 6b notifies the user of at least one of information indicating that the user has gotten on a wrong car 1 and information indicating the allocated car by display.

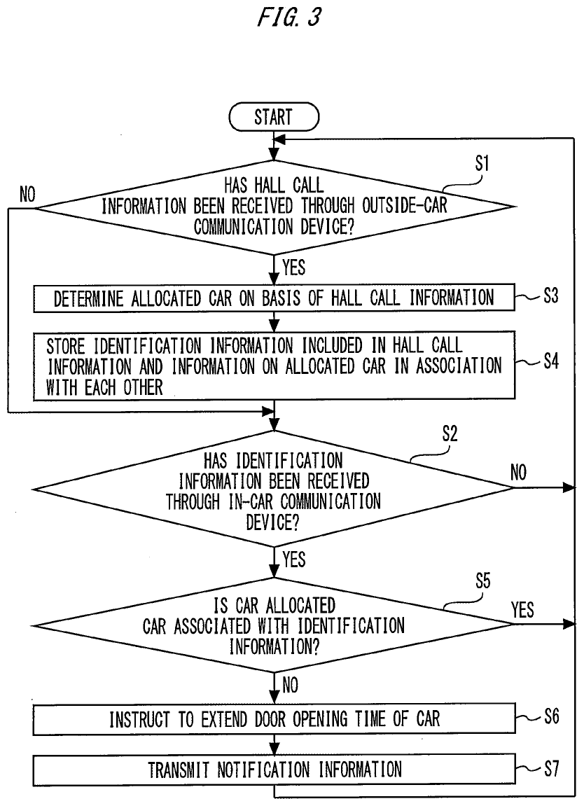

Next, the outline of the operation of the group management device 5 is described with reference to FIG. 3.

FIG. 3 is a flowchart for describing the outline of the operation of the group management device in the elevator system in Embodiment 1 of the present invention.

In Step S1, the group management device 5 determines whether hall call information has been received through the outside-car communication device 2. When the group management device 5 has not received hall call information through the outside-car communication device 2 in Step S1, the group management device 5 performs operation in Step S2.

In Step S2, the group management device 5 determines whether identification information has been received through the in-car communication device 3. When the group management device 5 has not received identification information through the in-car communication device 3 in Step S2, the group management device 5 repeats the operation from Step S1.

When the group management device 5 has received hall call information through the outside-car communication device 2 in Step S1, the group management device 5 performs operation in Step S3.

In Step S3, the group management device 5 determines an allocated car on the basis of the hall call information. After that, the group management device 5 performs operation in Step S4. In Step 4, the group management device 5 stores identification information included in the hall call information and information on the allocated car in association with each other. After that, the group management device 5 performs the operation in Step S2.

When the group management device 5 has received identification information through the in-car communication device 3 in Step S2, the group management device 5 performs operation in Step S5.

In Step S5, the group management device 5 determines whether the car 1 is an allocated car associated with the identification information. When the car 1 is an allocated car associated with the identification information in Step S5, the group management device 5 repeats the operation from Step S1. When the car 1 is not an allocated car associated with the identification information in Step S5, the group management device 5 performs operation in Step S6.

In Step S6, the group management device 5 instructs the corresponding control device 4 to extend a door opening rime of the car 1. Ater that, the group management device 5 performs operation in Step S7. In Step S7, the group management device 5 transmits notification information to the control device 4 corresponding to the car 1. After that, the group management device 5 repeats the operation from Step S1.

According to Embodiment 1 described above, the group management device 5 causes the in-car communication device 3 to transmit information indicating that a user has gotten on a wrong car 1 to the portable terminal 6. Thus, the information is notified to a target user. As a result, the privacy of the user can be protected.

The group management device 5 causes the in-car communication device 3 to transmit information indicating an allocated car to the portable terminal 6. Thus, the information is notified to a target user. As a result, the user can be guided to an appropriate car 1 while the privacy of the user is protected. For example, specific information that “please get off the car and get on the second car from the right” may be notified to the user. In this case, the user can be guided to an appropriate car 1 in more detail.

The group management device 5 determines an allocated car on the basis of a destination floor input from the portable terminal 6. Thus, even when a user selects a desired destination floor, the user can be notified that the user has gotten on a wrong car 1 while the privacy of the user is protected.

The group management device 5 determines an allocated car on the basis of a theme input from the portable terminal 6. Thus, even when a user selects a favorite theme, the user can be notified that the user has gotten on a wrong car 1 while the privacy of the user is protected. For example, when a user selects an elevator with a theme corresponding to his/her favorite interior, if other users in a car 1 on which the user has gotten by mistake are unintentionally notified of a car 1 corresponding to likes and preferences of the user, this leads to the invasion of privacy of the user. In Embodiment 1, on the other hand, the user is individually notified that the user has gotten on a wrong car 1. This can avoid the risk that other users in a car 1 on which the user has gotten by mistake are unintentionally notified of a car 1 corresponding to likes and preferences of the user. As a result, the privacy of the user can be reliably protected.

According to the elevator system in Embodiment 1, even when a plurality of users have gotten on the same wrong car 1 at the same time, appropriate information is transmitted to each of portable terminals 6 of the plurality of users. Thus, each of the plurality of users can be guided to an appropriate car 1.

Information from the portable terminal 6 may be transmitted to the group management device 5 through a mobile network. Also in this case, at least one of information indicating that a user has gotten on a wrong car 1 and information indicating an allocated car is notified to a target user. As a result, the privacy of the user can be protected.

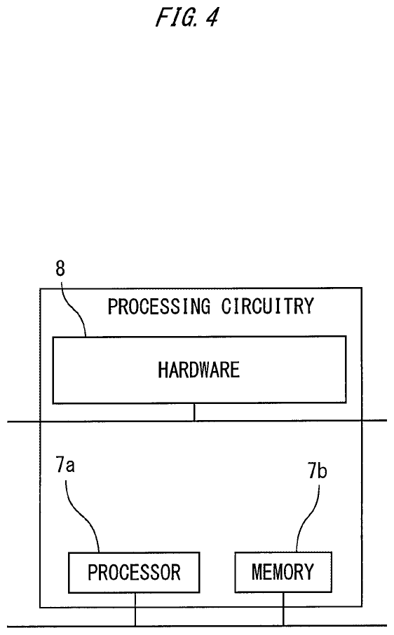

Next, an example of the group management device 5 is described with reference to FIG. 4.

FIG. 4 is a hardware configuration diagram of the group management device in the elevator system in Embodiment 1 of the present invention.

The functions of the group management device 5 can be implemented by a processing circuitry. For example, the processing circuitry includes at least one processor 7a and at least one memory 7b. For example, the processing circuitry includes at least one dedicated hardware 8.

When the processing circuitry includes at least one processor 7a and at least one memory 7b, the functions of the group management device 5 are implemented by software, firmware, or a combination of software and firmware. At least one of software and firmware is written as a program. At least one of software and firmware is stored in at least one memory 7b. The at least one processor 7a implements the functions of the group management device 5 by reading and executing a program stored in the at least one memory 7b. The at least one processor 7a may be a central processing unit (CPU), a central processing unit, a processing device, an arithmetic unit, a microprocessor, a microcomputer, or a DSP. Examples of the at least one memory 7b include non-volatile and volatile semiconductor memories, such as a RAM, a ROM, a flash memory, an EPROM, and an EEPROM, a magnetic disk, a flexible disk, an optical disc, a compact disk, a minidisc, and a DVD.

When the processing circuitry includes at least one dedicated hardware 8, the processing circuitry can be implemented by, for example, a single circuitry, a composite circuitry, a programmed processor, a parallel programmed processor, an ASIC, an FPGA, or a combination thereof. For example, the functions of the group management device 5 are each implemented by the processing circuitry. For example, the functions of the group management device 5 are collectively implemented by the processing circuitry.

A part of the functions of the group management device 5 may be implemented by the dedicated hardware 8, and the other part may be implemented by software or firmware. For example, the function of the car allocation unit 5a may be implemented by a processing circuitry as the dedicated hardware 8, and the functions other than the function of the car allocation unit 5a may be implemented by the at least one processor 7a reading and executing a program stored in the at least one memory 7b.

As described above, the processing circuitry implements each function of the group management device 5 by the hardware 8, software, firmware, or a combination thereof.

### INDUSTRIAL APPLICABILITY

As described above, the elevator system according to the present invention can be used for a system configured to protect the privacy of users.

### REFERENCE SIGNS LIST

1 Car
2 Outside-car communication device
3 In-car communication device
4 Control device
5 Group management device
5a Car allocation unit
5b Storage unit
5c Operation control unit
5d Mis-riding determination unit
5e Notification control unit
6 Portable terminal
6a Operation unit
6b Notification unit
7a Processor
7b Memory
8 Hardware

1. An elevator system, comprising:
a plurality of in-car communication devices disposed in corresponding ones of a plurality of respective cars; and
group management circuitry configured to, when the in-car communication device in the corresponding car that has arrived at a hall receives identification information from a portable terminal by wireless communication and when the car is not one of the plurality of cars to which a call has been allocated on the basis of input from the portable terminal corresponding to the identification information, cause the in-car communication device in the corresponding car to transmit information indicating that a user has gotten on a wrong car to the portable terminal by wireless communication.

2. The elevator system according to claim 1, wherein when the in-car communication device in the corresponding car that has arrived at the hall receives identification information from the portable terminal wireless communication and when the car is not one of the cars to which a call at the hall has been allocated on the basis of input from the portable terminal corresponding to the identification information, the group management circuitry causes the in-car communication device in the car to transmit, to the portable terminal by wireless communication, information indicating one of the corresponding cars to which the call has been allocated on the basis of the input from the portable terminal corresponding to the identification information.

3. The elevator system according to claim 1, wherein the group management circuitry determines one of the plurality of cars to which a call is allocated on the basis of a destination floor input from the portable terminal.

4. The elevator system according to claim 1, wherein the group management circuitry determines one of the plurality of cars to which a call is allocated on the basis of a theme input from the portable terminal.
